(19) United States
(12) Patent Application Publication
(10) Pub. No.: US 2015/0097781 A1
(43) Pub. Date: Apr. 9, 2015

(54) Multifunction electronic device

(71) Applicant: Hui-Chuan Lee, Kaohsiung (TW)

(72) Inventors: Hui-Chuan Lee, Kaohsiung (TW); Shu-Yu Chuang, Taoyuan (TW); Tyng-Tyng Lin, New Taipei City (TW); Pei-Ching Liu, Hsinchu (TW); Yi-Hsuan Lai, New Taipei City (TW); Yi-Sheng Chen, Taichung (TW)

(73) Assignee: Hui-Chuan Lee, Kaohsiung (TW)

(21) Appl. No.: 14/049,198

(22) Filed: Oct. 8, 2013

(51) Int. Cl. G06F 3/02; G06F 3/041

(52) U.S. Cl. CPC G06F 3/0227; G06F 3/0416
USPC 345/169

(57) ABSTRACT

A multifunction electronic device is provided with, in one embodiment, a controller; a wireless Internet access unit; an audio recording unit; a laser pointing unit; a data storage unit including a port; a multi-touch display; a key-based operation unit; a rechargeable power source; and a power socket electrically connected to the rechargeable power source. The rechargeable power source is electrically connected to the controller. The controller is electrically connected to the wireless Internet access unit, the audio recording unit, the laser pointing unit, the data storage unit, the multi-touch display, the key-based operation unit. The controller is activated by the key-based operation unit to activate the laser pointing unit. The controller is activated by the key-based operation unit to activate at least one of the wireless Internet access unit, the audio recording unit, and the data storage unit.

### BACKGROUND OF THE INVENTION

1. Field of the Invention

The invention relates to electronic devices and more particularly to a multifunction electronic device.

2. Description of Related Art

Typically, an individual may carry a Universal Serial Bus (USB) flash drive, a laser pointer, a card reader, etc. if such need is required. However, it is not convenient to carry all of them. Further, loss of at least one of them is possible if sufficient care is not taken. Thus, the need for a multifunction electronic device exists.

### SUMMARY OF THE INVENTION

It is therefore one object of the invention to provide a multifunction electronic device comprising a controller; a wireless Internet access unit; an audio recording unit; a laser pointing unit; a data storage unit including a port; a multi-touch display; a key-based operation unit; a rechargeable power source; and a power socket electrically connected to the rechargeable power source; wherein the rechargeable power source is electrically connected to the controller; wherein the controller is electrically connected to the wireless Internet access unit, the audio recording unit, the laser pointing unit, the data storage unit, the multi-touch display, the key-based operation unit; wherein the controller is activated by the key-based operation unit to activate the laser pointing unit; and wherein the controller is activated by the key-based operation unit to activate at least one of the wireless Internet access unit, the audio recording unit, and the data storage unit.

The above and other objects, features and advantages of the invention will become apparent from the following detailed description taken with the accompanying drawings.

### BRIEF DESCRIPTION OF THE DRAWINGS

FIG. 1 is a block diagram of a first preferred embodiment of a multifunction electronic device according to the invention;

FIG. 2 is a block diagram of a second preferred embodiment of a multifunction electronic device according to the invention; and

FIG. 3 is a block diagram of a third preferred embodiment of a multifunction electronic device according to the invention.

### DETAILED DESCRIPTION OF THE INVENTION

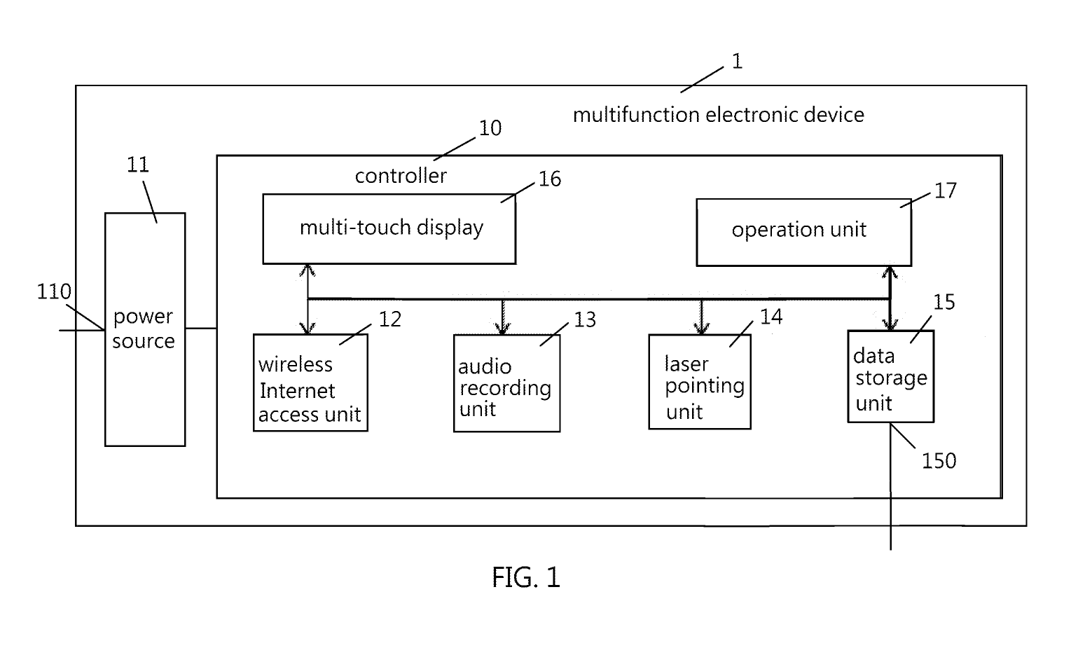

Referring to FIG. 1, a multifunction electronic device 1 in accordance with a first preferred embodiment of the invention comprises the following components as discussed in detail below.

A printed circuit board (PCB)-based controller 10 is provided. A rechargeable power source 11 is electrically connected to the controller 10. A wireless Internet access unit 12, an audio recording unit 13, a laser pointing unit 14, and a data storage unit 15 are provided and electrically connected to the controller 10. A multi-touch display 16 and a key-based operation unit 17 are provided on the electronic device 1 and electrically connected to the wireless Internet access unit 12, the audio recording unit 13, the laser pointing unit 14, and the data storage unit 15. A power socket 110 is provided on the electronic device 1 and electrically connected to the power source 11. A port 150 is provided on the electronic device 1 and connected to the data storage unit 15. The power source 11 is used to supply power to all of above components for normal operation.

A user may manipulate the multi-touch display 16 to execute a desired function such as wireless Internet access, access data from the data storage unit 15, etc. The user may use a computer or smartphone to send data from the data storage unit 15 to a cloud drive for storage. An external device may be connected to the electronic device 1 by connecting to the port 150. The user may use the audio recording unit 13 to record a conversation or the like. The user may manipulate the operation unit 17 to cause the laser pointing unit 14 to emit a laser beam of visible light in, for example, a business presentation. The power source 11 is a rechargeable battery. The electronic device 1 can be used to charge a second electronic device by connecting a connector of the second electronic device to the power socket 110. Alternatively, a connector of an adapter (e.g., transformer) may be connected to the power socket 110 for charging the discharged power source 11.

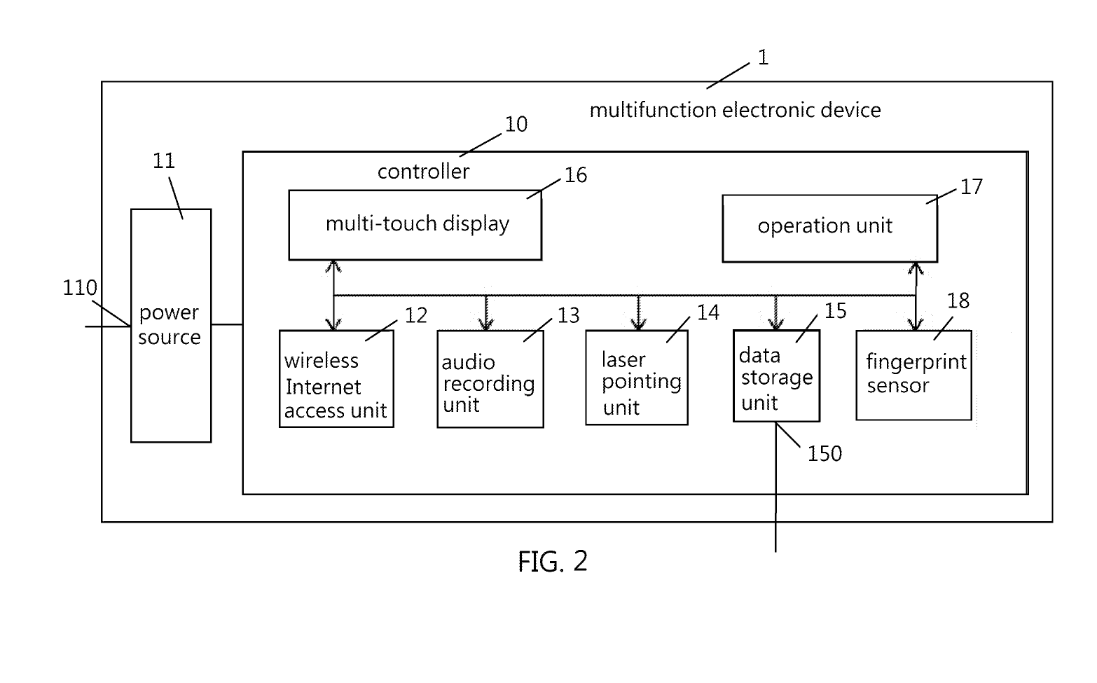

Referring to FIG. 2, a multifunction electronic device 1 in accordance with a second preferred embodiment of the invention is shown. The characteristics of the second preferred embodiment are substantially the same as that of the first preferred embodiment except the following:

A fingerprint sensor 18 is electrically connected to the operation unit 17. Further, the fingerprint sensor 18 is electrically connected to the wireless Internet access unit 12, the audio recording unit 13, the laser pointing unit 14, the data storage unit 15, and the multi-touch display 16. The fingerprint sensor 18 is functioned as a log-in authentication for the identification of the multifunction electronic device 1.

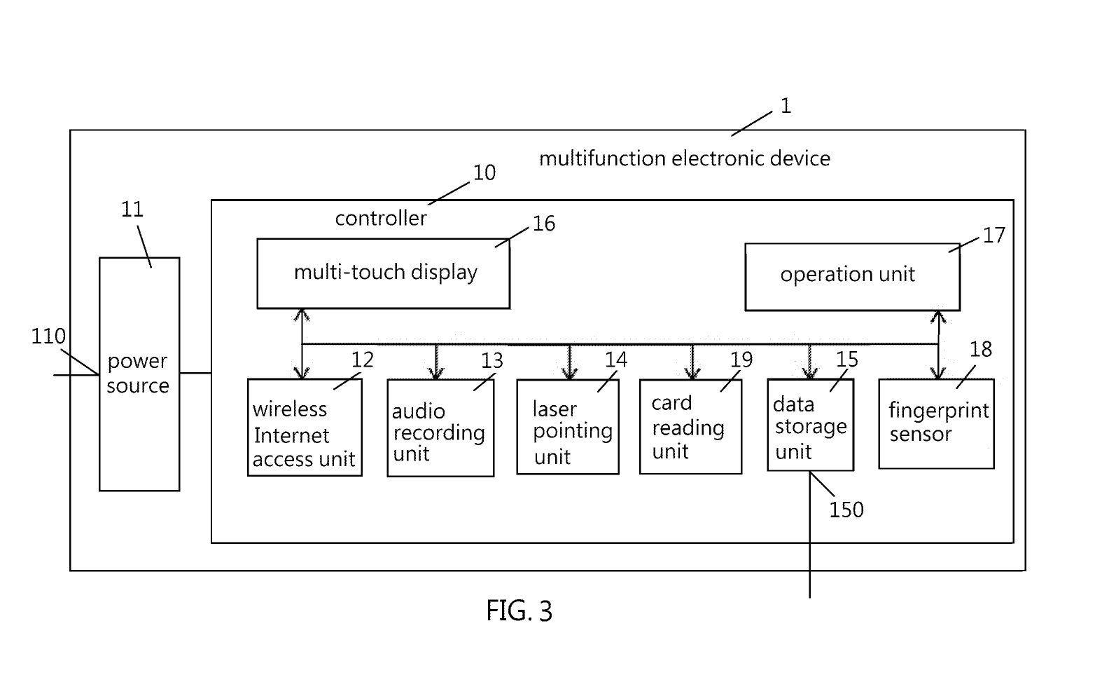

Referring to FIG. 3, a multifunction electronic device 1 in accordance with a third preferred embodiment of the invention is shown. The characteristics of the third preferred embodiment are substantially the same as that of the first preferred embodiment except the following:

A card reading unit 19 is electrically connected to the operation unit 17, the fingerprint sensor 18, the wireless Internet access unit 12, the audio recording unit 13, the laser pointing unit 14, the data storage unit 15, and the multi-touch display 16. The card reading unit 19 is used to read data from the data storage unit 15.

While the invention has been described in terms of preferred embodiments, those skilled in the art will recognize that the invention can be practiced with modifications within the spirit and scope of the appended claims.

What is claimed is:

1. A multifunction electronic device comprising:
a controller;
a wireless Internet access unit;
an audio recording unit;
a laser pointing unit;
a data storage unit including a port;
a multi-touch display;
a key-based operation unit;
a rechargeable power source; and
a power socket electrically connected to the rechargeable power source;
wherein the rechargeable power source is electrically connected to the controller;
wherein the controller is electrically connected to the wireless Internet access unit, the audio recording unit, the laser pointing unit, the data storage unit, the multi-touch display, the key-based operation unit;
wherein the controller is activated by the key-based operation unit to activate the laser pointing unit; and
wherein the controller is activated by the key-based operation unit to activate at least one of the wireless Internet access unit, the audio recording unit, and the data storage unit.

2. The multifunction electronic device of claim 1, further comprising a fingerprint sensor electrically connected to the key-based operation unit, the wireless Internet access unit, the audio recording unit, the laser pointing unit, the data storage unit, and the multi-touch display.

3. The multifunction electronic device of claim 2, further comprising a card reading unit electrically connected to the key-based operation unit, the fingerprint sensor, the wireless Internet access unit, the audio recording unit, the laser pointing unit, the data storage unit, and the multi-touch display.
